(19) United States
(12) Patent Application Publication
(10) Pub. No.: US 2021/0383605 A1
(43) Pub. Date: Dec. 9, 2021

(54) DRIVING METHOD AND APPARATUS OF AN AVATAR, DEVICE AND MEDIUM

(71) Applicant: BEIJING BAIDU NETCOM SCIENCE AND TECHNOLOGY CO., LTD., Beijing (CN)

(72) Inventors: Haotian PENG, Beijing (CN); Ruizhi CHEN, Beijing (CN)

(73) Assignee: BEIJING BAIDU NETCOM SCIENCE AND TECHNOLOGY CO., LTD., Beijing (CN)

(21) Appl. No.: 17/412,977

(22) Filed: Aug. 26, 2021

(30) Foreign Application Priority Data
Oct. 30, 2020 (CN) 202011192132.0

(51) Int. Cl. G06T 17/20; G06T 19/20

(52) U.S. Cl. CPC G06T 17/205; G06T 2219/2016; G06T 19/20

(57) ABSTRACT

Provided are a driving method and apparatus of an avatar, a device and a medium. The method includes acquiring the skin weight of each skin vertex associated with the current bone node in the skinned mesh model of the avatar; acquiring target avatar data of the skinned mesh model when a picture to be converted is converted into the avatar; determining the bone driving factor of the skinned mesh model based on the skin weight, basic avatar data of the skinned mesh model and the target avatar data; and driving the skinned mesh model based on a bone driving factor of each bone node.

### CROSS-REFERENCES TO RELATED APPLICATIONS

This application claims priority to a Chinese patent application No. 202011192132.0 filed on Oct. 30, 2020, the disclosure of which is incorporated herein by reference in its entirety.

### TECHNICAL FIELD

The present application relates to the field of data processing technology, especially the field of augmented reality and deep learning, specifically a driving method and apparatus of an animated image, a device and a medium.

### BACKGROUND

With the continuous development of technologies, the augmented reality technology emerges. An avatar may be driven to imitate an expression or gesture of a real image, increasing the user pleasure.

In the related art, when an avatar is driven based on a real image, a large difference occurs between the driving result and an expression or gesture of a real image, degrading the user experience.

### SUMMARY

The present application provides a driving method and apparatus of an avatar, a device and a medium that have a higher degree of matching.

According to one aspect of the present application, a driving method of an avatar is provided. The method includes acquiring the skin weight of each skin vertex associated with the current bone node in the skinned mesh model of the avatar; acquiring target avatar data of the skinned mesh model when a picture to be converted is converted into the avatar; determining a bone driving factor of the skinned mesh model based on the skin weight, basic avatar data of the skinned mesh model and the target avatar data; and driving the skinned mesh model based on a bone driving factor of each bone node.

According to another aspect of the present application, a driving apparatus of an avatar is provided. The apparatus includes a skin weight acquisition module, a target avatar data acquisition module, a bone driving factor determination module and a skinned mesh model driving module.

The skin weight acquisition module is configured to acquire the skin weight of each skin vertex associated with the current bone node in the skinned mesh model of the avatar.

The target avatar data acquisition module is configured to acquire target avatar data of the skinned mesh model when a picture to be converted is converted into the avatar.

The bone driving factor determination module is configured to determine the bone driving factor of the skinned mesh model based on the skin weight, basic avatar data of the skinned mesh model and the target avatar data.

The skinned mesh model driving module is configured to drive the skinned mesh model based on the bone driving factor of each bone node.

According to another aspect of the present application, an electronic device is provided. The device includes at least one processor and a memory communicatively connected to the at least one processor.

The memory stores instructions executable by the at least one processor to enable the at least one processor to perform the driving method of an avatar according to any one of embodiments of the present application.

According to another aspect of the present application, a non-transitory computer-readable storage medium is provided. The storage medium stores computer instructions for causing a computer to perform the driving method of an avatar according to any one of embodiments of the present application.

With the technology of the present application, the degree of matching between the driving result of the avatar and the target avatar data is improved.

It is to be understood that the content described in this part is neither intended to identify key or important features of embodiments of the present disclosure nor intended to limit the scope of the present disclosure. Other features of the present disclosure are easier to understand through the description provided hereinafter.

### BRIEF DESCRIPTION OF DRAWINGS

The drawings are intended to provide a better understanding of the present solution and not to limit the present application.

FIG. 1A is a flowchart of a driving method of an avatar according to an embodiment of the present application.

FIG. 1B is a diagram illustrating the structure of the bone nodes and skinned mesh of an avatar according to an embodiment of the present application.

FIG. 2 is a flowchart of another driving method of an avatar according to an embodiment of the present application.

FIG. 3 is a flowchart of another driving method of an avatar according to an embodiment of the present application.

FIG. 4 is a flowchart of another driving method of an avatar according to an embodiment of the present application.

FIG. 5A is a flowchart of another driving method of an avatar according to an embodiment of the present application.

FIG. 5B is a diagram of avatar data according to an embodiment of the present application.

FIG. 5C is a diagram of weighted-decentralized avatar data according to an embodiment of the present application.

FIG. 5D is a diagram of avatar enhancement data according to an embodiment of the present application.

FIG. 5E is a diagram of an iteration result according to an embodiment of the present application.

FIG. 5F is a diagram of a rigid transformation result according to an embodiment of the present application.

FIG. 6 is a diagram illustrating the structure of a driving apparatus of an avatar according to an embodiment of the present application.

FIG. 7 is a block diagram of an electronic device for performing a driving method of an avatar according to an embodiment of the present application.

### DETAILED DESCRIPTION

Example embodiments of the present application, including details of embodiments of the present application, are described hereinafter in connection with the drawings to facilitate understanding. The example embodiments are illustrative only. Therefore, it is to be understood by those having ordinary skill in the art that various changes and modifications may be made to the embodiments described herein without departing from the scope and spirit of the present application. Similarly, description of well-known functions and constructions is omitted hereinafter for clarity and conciseness.

Each driving method of an avatar and each driving apparatus of an avatar provided in embodiments of the present application are applicable to a case where the basic skinned mesh model of the avatar is driven when a user's picture to be converted is converted into the avatar in the field of augmented reality and deep learning. The method may be performed by the driving apparatus of an avatar. The apparatus is implemented as software and/or hardware and disposed in an electronic device.

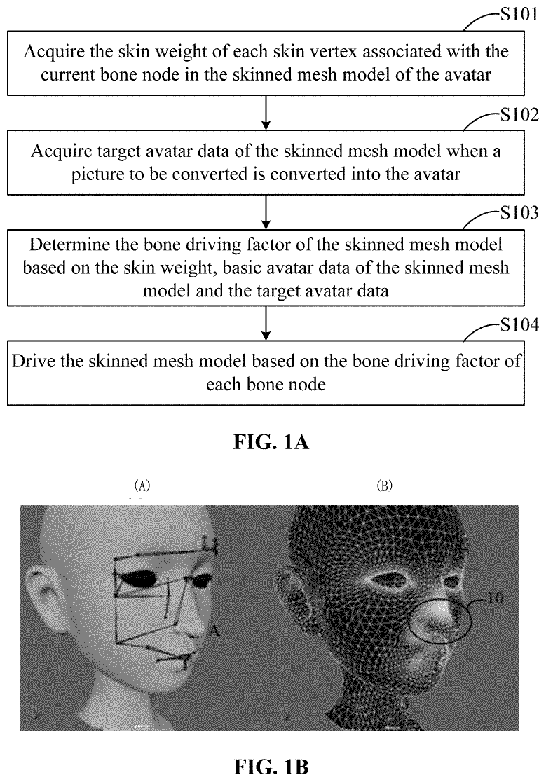

FIG. 1A is a flowchart of a driving method of an avatar. The method includes the steps below.

In S101, the skin weight of each skin vertex associated with the current bone node in the skinned mesh model of the avatar is acquired.

The avatar may be construed as an image, such as a cartoon image, constructed based on, for example, a virtual character, a virtual animal or a virtual plant.

The skinned mesh model is a model structure constructed by a skilled person when the skilled person designs an avatar and is used for uniquely representing a corresponding avatar. The skinned mesh model may include two parts: bone nodes and a skinned mesh. A bone node tree may be constructed based on associations between the bone nodes so that the bone nodes can be searched for and used easily. The skinned mesh includes at least one skin vertex attached to the bone. Each skin vertex can be controlled by multiple bone nodes. It is to be noted that one skin vertex can be controlled by at least one bone node; therefore, to distinguish between the degree of control of a skin vertex by one bone node and the degree of control of the skin vertex by a different bone node, it is needed to set the skin weight of the skin vertex controlled by each bone node when the skinned mesh model is constructed. The sum of skin weights corresponding to bone nodes that can control the same skin vertex is 1. The value of the skin weight may be determined or adjusted by the designer of the skinned mesh model of the avatar based on design experience, intuition and experimentation.

FIG. 1B is a diagram illustrating the structure of the bone nodes and skinned mesh of an avatar. Lines of FIG. (A) of FIG. 1B indicate the hierarchical structure of the bone nodes.

The points of intersection between the lines are the bone nodes. FIG. (B) of FIG. 1B shows the skinned mesh corresponding to the bone nodes of FIG. (A). The grayscale of area 10 of FIG. (B) indicates the degree of control, that is, skin weight, of the associated skinned mesh by bone node A of FIG. (A). The white weight is 1. The black weight is 0.

The skinned mesh model may be driven to experience a rigid transformation that leads to different transformed images of the avatar. The rigid transformation includes at least one of rotation, translation or scaling.

The skin weight of the skin vertex associated with each bone node in the skinned mesh model of the avatar may be prestored locally in an electronic device, in other storage devices associated with the electronic device or in the cloud. Correspondingly, when the avatar needs to be driven, the skin weight is acquired from the corresponding storage area through the avatar identifier and the bone node identifier.

In S102, target avatar data of the skinned mesh model is acquired when a picture to be converted is converted into the avatar.

The picture to be converted may be construed as a picture that needs to be converted into the avatar, for example, a picture collected by a user in real time or downloaded in a set storage area.

The avatar data of the skinned mesh model may be point cloud data formed by position information of each skin vertex in the skinned mesh model.

The target avatar data may be construed as avatar data corresponding to the skinned mesh model when the avatar imitates information such as expression and/or gesture information in the picture to be converted.

It is feasible to obtain the target avatar data by three-dimensional animation processing of the picture to be converted. It is to be noted that it is feasible to obtain the target avatar data by processing, in any three-dimensional animation processing manner in the related art, the picture to be processed. The method for obtaining the target avatar data is not limited in the embodiments of this application. Exemplarily, it is feasible to obtain the target avatar data by processing, through a linear model constructed through multiple preconstructed blend shape (BS) models, the picture to be processed.

To simplify the data calculation amount of the process of driving the avatar, it is feasible to migrate the process of determining the target avatar data to another terminal, to implement the process of determining the target avatar data in the another terminal, and then to store the determination result in an electronic device for performing the driving method of an avatar or in another device associated with the electronic device so that the determination result can be searched for and acquired.

In S103, the bone driving factor of the skinned mesh model is determined based on the skin weight, basic avatar data of the skinned mesh model and the target avatar data.

The bone driving factor is used for representing parameters according to which the current bone node in the skinned mesh model is driven. The driving process can be construed as a process of rigidly transforming the basic avatar data of the skinned mesh model.

In an embodiment, the bone driving factor may include a target rotation factor. The target rotation factor is used for representing rotation control parameters when rotation control of position information (basic avatar data) of each skin vertex is performed when the avatar is driven. Alternatively, the bone driving factor may further include a target scaling factor. The target scaling factor is used for representing scaling control parameters when scaling control of position information (basic avatar data) of each skin vertex is performed when the avatar is driven. Alternatively, the bone driving factor may further include a target translation factor. The target translation factor is used for representing translation control parameters when translation control of position information (basic avatar data) of each skin vertex is performed when the avatar is driven.

In this embodiment of the present application, the bone driving factor may include the target rotation factor, the target scaling factor and the target translation factor. It is to be noted that when rotation, scaling and translation of the basic avatar data are performed, due to factors such as coordinate transformation, the order of rotation, scaling and translation varies, and the finally determined bone driving factor also varies. Since the impact of translation and scaling on the basic avatar data can be eliminated in a manner of data processing, the bone driving factor is determined generally in the order of “target rotation factor-target scaling factor-target translation factor”. It is to be understood that when no rotation, scaling or translation of the basic avatar data is required, the corresponding target rotation factor, target scaling factor or target translation factor may be determined to be a unit matrix. Therefore, when the bone driving factor includes at least one of the target rotation factor, the target scaling factor or the target translation factor, the bone driving factor may still be determined in the order of “target rotation factor-target scaling factor-target translation factor”.

Exemplarily, the basic avatar data and/or the target avatar data of the skinned mesh model may be processed through the skin weight, and the bone driving factor of the skinned mesh model may be determined based on the processed data.

It is to be noted that the skin weight represents the degree of control of the corresponding skin vertex by the current bone node, that is, the degree of control of a skin vertex by one bone node is distinguished from the degree of control of the skin vertex by a different bone node; in this manner, in the process of determining the bone driving factor, the bone driving factor of the current bone node can be determined, and the impact of other bone nodes on the skin vertex associated with the current bone node is eliminated.

In an optional embodiment, the basic avatar data and the target avatar data may be weighted through the skin weight; the weight processing result may be processed at one time through Procrustes analysis so that the target rotation factor of the skinned mesh model is obtained; the target scaling factor of the skinned mesh model may be obtained based on the weighted root-mean-square error of the weighted target avatar data and the weighted root-mean-square error of the weighted basic avatar data; and the target translation factor of the skinned mesh model may be determined based on the difference between the weighted target avatar data and the weighted basic avatar data.

Since the weight processing result is processed at one time through Procrustes analysis, the accuracy of the determined bone driving factor is relatively low, thereby affecting the degree of matching between the driving result of the avatar and the target avatar data. To avoid the preceding, it is feasible to determine at least one bone driving factor in a manner of loop iteration until an iteration termination condition is satisfied. The iteration termination condition may be as follows: The driving result of the avatar of the determined bone driving factor is approximate to the target avatar data, that is, the error is less than a set error threshold; or a set number of iterations is reached. The set error threshold or the set number of iterations is determined by a skilled person according to needs or an empirical value.

In another optional embodiment, the intermediate avatar data and the target avatar data may be processed through the skin weight, where the intermediate avatar data is obtained by rigidly transforming the basic avatar data based on the current bone driving factor; the weight processing result may be processed at one time through Procrustes analysis so that the current bone driving factor is obtained; and the intermediate avatar data is updated through the current bone driving factor. Such operation is iterated until the iteration termination condition is satisfied. The iteration termination condition may be as follows: The finally determined intermediate avatar data is approximate to the target avatar data, that is, the error is less than the set error threshold; or the set number of iterations is reached. The set error threshold or the set number of iterations is determined by a skilled person according to needs or an empirical value. The initial value of the current bone driving factor may be determined based on a unit matrix.

In S104, the skinned mesh model is driven based on the bone driving factor of each bone node.

Exemplarily, the basic avatar data of the skinned mesh model is rigidly transformed based on the bone driving factor of each bone node so that the driving result of the avatar is obtained for the purpose of display.

It is to be noted that the electronic device for driving the skinned mesh model may be the same as or different from the electronic device for determining the bone driving factor. For example, the bone driving factor is determined by a server, and the determined bone driving factor is sent to a terminal device, and then the local skinned mesh model is driven in the terminal device based on the bone driving factor. The skinned mesh model in the terminal device is the same as the skinned mesh model in the server.

In this embodiment of the present application, the skin weight of each skin vertex associated with the current bone node is adopted in the process of determining the bone driving factor, and the impact of other bone nodes on the skin vertex associated with the current bone node is eliminated by the skin weight. In this manner, the accuracy of the determination result of the bone driving factor of the current bone node is improved, and thus the degree of matching between the target avatar data and the driving result of driving the avatar based on the bone driving factor is improved.

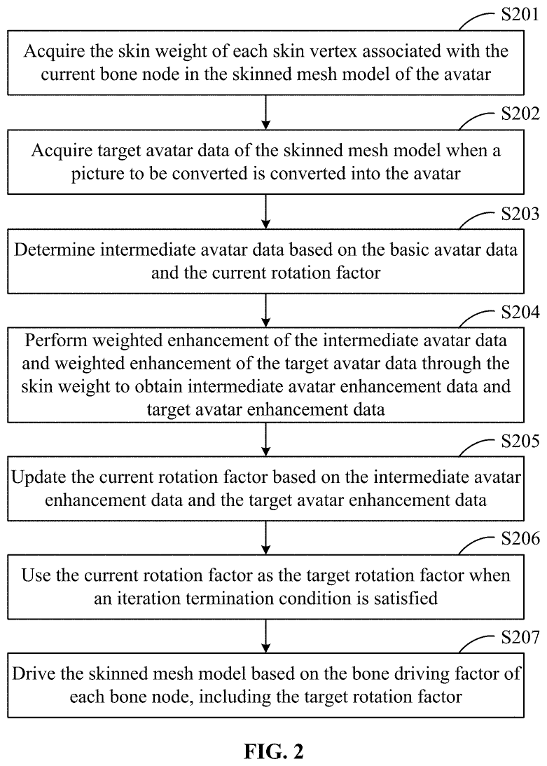

Exemplarily, the bone driving factor may include a target rotation factor. In an optional embodiment of the present application, the generation mechanism of the target rotation factor is optimized and improved based on each preceding solution. FIG. 2 is a flowchart of another driving method of an avatar. With further reference to FIG. 2, the method includes the steps below.

In S201, the skin weight of each skin vertex associated with the current bone node in the skinned mesh model of the avatar is acquired.

In S202, target avatar data of the skinned mesh model is acquired when a picture to be converted is converted into the avatar.

In S203, intermediate avatar data is determined based on the basic avatar data and the current rotation factor.

The current rotation factor may be data updated in the previous iteration process. The current iteration factor in the first iteration process may be determined by a skilled person according to needs or an empirical value. For example, the current rotation factor may be set to a unit matrix or a random matrix.

Exemplarily, rotation processing of the basic avatar data is performed based on the current rotation factor so that the intermediate avatar data is obtained. The intermediate avatar data may be construed as avatar data which is used for the purpose of intermediate transition and is determined in each iteration process when the basic avatar data is converted into the target avatar data. It is to be understood that as the number of iterations increases, the intermediate avatar data is gradually approximate to the target avatar data, thereby making the finally determined current rotation factor more accurate.

In S204, weighted enhancement of the intermediate avatar data and weighted enhancement of the target avatar data are performed through the skin weight so that intermediate avatar enhancement data and target avatar enhancement data are obtained.

The weighting operation means that the position data of each skin vertex in the intermediate avatar data is weighted through the skin weight of the each skin vertex so that the intermediate avatar enhancement data is obtained; and the target avatar data is weighted through the skin weight of the each skin vertex so that the target avatar enhancement data is obtained.

Weighted enhancement of the intermediate avatar data and weighted enhancement of the target avatar data are performed through the skin weight. In this manner, the control impact of other bone nodes on the skin vertex associated with the current bone node is eliminated, and thereby intermediate avatar enhancement data and target avatar enhancement data associated with only the current bone node are obtained.

In S205, the current rotation factor is updated based on the intermediate avatar enhancement data and the target avatar enhancement data.

In an embodiment, a rotation factor increment is determined when the intermediate avatar enhancement data is converted into the target avatar enhancement data; and the current rotation factor determined through the previous iteration (that is, the current rotation factor used when the intermediate avatar data is determined) is updated based on the rotation factor increment.

Exemplarily, the rotation factor increment may be determined using the orthogonal Procrustes method when the intermediate avatar enhancement data is converted into the target avatar enhancement data.

In an implementation, two sets of orthogonal basis vectors of the intermediate avatar enhancement data and the target avatar enhancement data are determined using the singular value decomposition method. Of the two sets of orthogonal basis vectors, one set of orthogonal basis vectors is a combination of orthogonal input basis vectors of a product matrix of the target avatar enhancement data and the transpose of the intermediate avatar enhancement data, and the other set of orthogonal basis vectors is a combination of orthogonal output basis vectors of a product matrix of the target avatar enhancement data and the transpose of the intermediate avatar enhancement data. A product matrix of the two sets of orthogonal basis vectors is determined and used as the matrix value of the rotation factor increment.

In S206, the current rotation factor is used as the target rotation factor when an iteration termination condition is satisfied.

In an embodiment, the iteration termination condition may be satisfied in the following manner: The error between the intermediate avatar enhancement data and the target avatar enhancement data is less than a set error value. Alternatively, the error between the intermediate avatar enhancement data and the target avatar enhancement data in the iteration process tends to be stable. Alternatively, the number of iterations of the target rotation factor satisfies the set threshold of the number of iterations. The set error value or the set threshold of the number of iterations may be set by a skilled person according to needs or an empirical value or may be repeatedly determined or adjusted through a large number of experiments.

It is to be understood that the current rotation factor is continuously optimized so that the finally determined current rotation factor, that is, the target rotation factor, can more accurately represent the rotation of the basic avatar data to the target avatar data in the rigid transformation process of the current bone node.

In S207, the skinned mesh model is driven based on the bone driving factor of each bone node, including the target rotation factor.

In this embodiment of the present application, weighted enhancement of the intermediate avatar data and weighted enhancement of the target avatar data are performed through the skin weight. In this manner, the impact of other bone nodes on the skin vertex associated with the current bone node is eliminated, and thereby the accuracy of the target rotation factor corresponding to the current bone node is improved. Moreover, in the process of determining the target rotation factor, multiple iterations are performed to make the finally determined target rotation factor more accurate. Correspondingly, the driving result of the skinned mesh model matches the target avatar data better.

Based on the solution of each preceding embodiment, if a translation operation is also required in the process of rigidly transforming the basic avatar data to the target avatar data, then a change in the coordinate system or the coordinate origin caused by the translation operation affects the final result of the rotation operation, that is, affects the accuracy of the determination result of the target rotation factor.

To avoid the impact of the translation operation on the accuracy of the target rotation factor, in an optional embodiment, before determining the intermediate avatar data based on the basic avatar data and the current rotation factor, it is feasible to perform decentralization processing of the basic avatar data and decentralization processing of the target avatar data to update the basic avatar data and the target avatar data. Correspondingly, the intermediate avatar data is determined based on the updated basic avatar data and the current rotation factor; and weighted enhancement of the intermediate avatar data and weighted enhancement of the updated target avatar data are performed through the skin weight so that the intermediate avatar enhancement data and the target avatar enhancement data are obtained.

In an embodiment, the basic center point of the basic avatar data may be determined based on the position data of each skin vertex in the basic avatar data; and subtraction is performed between the point cloud data of each skin vertex in the basic avatar data and the point cloud data of the basic center point so that the basic avatar data is updated. In this manner, decentralization processing of the basic avatar data is implemented. Correspondingly, the target center point of the target avatar data may be determined based on the point cloud data of each skin vertex in the target avatar data; and subtraction is performed between the point cloud data of each skin vertex in the target avatar data and the position data of the target center point so that the target avatar data is updated. In this manner, decentralization processing of the target avatar data is implemented.

It is to be understood that the decentralization operation enables the coordinate system of the basic avatar data and the coordinate system of the target avatar data to be unified, thereby eliminating the impact of the translation operation on the accuracy of the target rotation factor.

In the process of determining the target rotation factor, weighted enhancement of the intermediate avatar data determined based on the basic avatar data and weighted enhancement of the target avatar data need to be performed through the skin weight, and the weighted centroid of the basic avatar data and the weighted centroid of the target avatar data are offset.

However, the kinetic stability of an object is closely related to the position of a centroid. That is, the offset of the weighted centroid affects accuracy of the determination result of the target rotation factor. To avoid the preceding situation, in an optional embodiment, the preceding decentralization processing may be optimized as weighted decentralization processing.

Exemplarily, decentralization processing of the intermediate avatar data and decentralization processing of the target avatar data may be performed in the following manner: The basic weighted centroid of the basic avatar data and the target weighted centroid of the target avatar data are determined based on the skin weight; and decentralization processing of the basic avatar data is performed based on the basic weighted centroid, and decentralization processing of the target avatar data is performed based on the target weighted centroid.

Weighted summation of the point cloud data of skin vertexes in the basic avatar data is performed through the skin weight so that the basic weighted centroid of the basic avatar data is determined; and subtraction is performed between the point cloud data of each skin vertex in the basic avatar data and the position data of the basic weighted centroid so that the basic avatar data is updated. In this manner, weighted decentralization processing of the basic avatar data is implemented. Correspondingly, weighted summation of the point cloud data of skin vertexes in the target avatar data is performed through the skin weight so that the target weighted centroid of the target avatar data is determined; and subtraction is performed between the point cloud data of each skin vertex in the target avatar data and the position data of the target weighted centroid so that the target avatar data is updated. In this manner, weighted decentralization processing of the target avatar data is implemented.

It is to be understood that the basic weighted centroid of the basic avatar data and the target weighted centroid of the target avatar data are determined based on the skin weight; and decentralization processing of the basic avatar data is performed based on the basic weighted centroid, and decentralization processing of the target avatar data is performed based on the target weighted centroid; in this manner, offset of the weighted centroid is avoided so that the determination result of the target rotation factor is not affected in accuracy by offset of the weighted centroid and thus is more accurate.

Based on each preceding solution, if a scaling operation is also required in the process of rigidly transforming the basic avatar data to the target avatar data, then the scaling operation affects the final result of the rotation operation, that is, affects the accuracy of the determination result of the target rotation factor.

To avoid the impact of the scaling operation on the accuracy of the target rotation factor, in an optional embodiment, before updating the current rotation factor based on the intermediate avatar enhancement data and the target avatar enhancement data, it is feasible to perform normalization processing of the intermediate avatar enhancement data and normalization processing of the target avatar enhancement data to update the intermediate avatar enhancement data and the target avatar enhancement data. Correspondingly, the current rotation factor is updated based on the updated intermediate avatar enhancement data and the updated target avatar enhancement data.

To avoid the impact of the scaling operation on the accuracy of the target rotation factor, in another optional embodiment, before updating the current rotation factor based on the intermediate avatar enhancement data and the target avatar enhancement data, it is feasible to perform normalization processing of the intermediate avatar data and normalization processing of the target avatar data to update the intermediate avatar data and the target avatar data. Correspondingly, the intermediate avatar data is determined based on the updated intermediate avatar data, and weighted enhancement of the updated target avatar data is performed through the skin weight.

In an embodiment, the normalization processing operation may be as follows: The statistical value of data to be processed is determined, and normalization processing of the data to be processed is performed based on the statistical value so that the data to be processed is updated. The data to be processed may be intermediate avatar data, intermediate avatar enhancement data, target avatar data or target avatar enhancement data. The statistical value includes at least one of a maximum value, a minimum value, a standard deviation, a variance or the like.

In an implementation, performing normalization processing of the intermediate avatar enhancement data and normalization processing of the target avatar enhancement data to update the intermediate avatar enhancement data and the target avatar enhancement data may include determining the intermediate weighted root-mean-square error of the intermediate avatar data and the target weighted root-mean-square error of the target avatar data based on the skin weight; and performing normalization processing of the intermediate avatar enhancement data based on the intermediate weighted root-mean-square error to update the intermediate avatar enhancement data and performing normalization processing of the target avatar enhancement data based on the target weighted root-mean-square error to update the target avatar enhancement data.

In another implementation, performing normalization processing of the intermediate avatar data and normalization processing of the target avatar data to update the intermediate avatar data and the target avatar data may include determining the intermediate weighted root-mean-square error of the intermediate avatar data and the target weighted root-mean-square error of the target avatar data based on the skin weight; and performing normalization processing of the intermediate avatar data based on the intermediate weighted root-mean-square error to update the intermediate avatar data and performing normalization processing of the target avatar data based on the target weighted root-mean-square error to update the target avatar data.

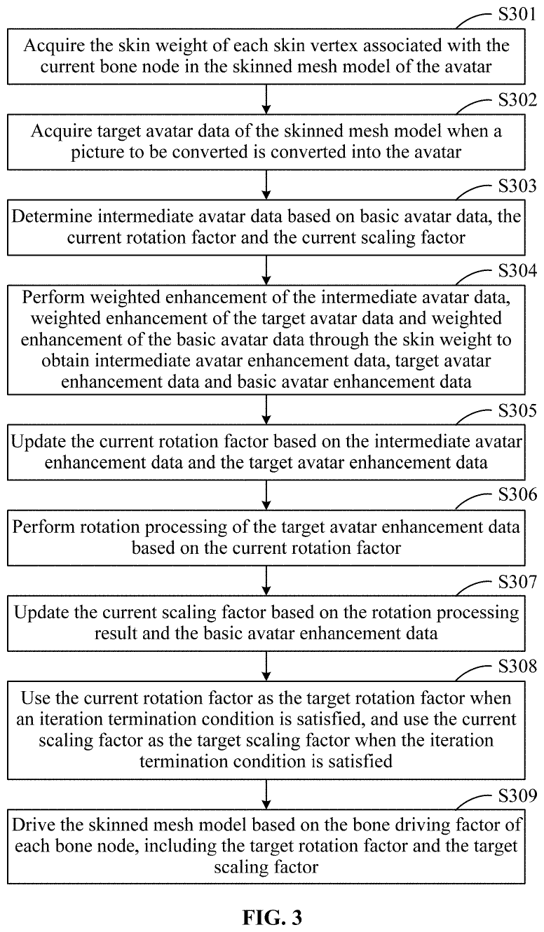

Exemplarily, the bone driving factor may further include a target scaling factor. In an optional embodiment of the present application, the generation mechanism of the target scaling factor is optimized and improved based on each preceding solution. FIG. 3 is a flowchart of a driving method of an avatar. With further reference to FIG. 3, the method includes the steps below.

In S301, the skin weight of each skin vertex associated with the current bone node in the skinned mesh model of the avatar is acquired.

In S302, target avatar data of the skinned mesh model is acquired when a picture to be converted is converted into the avatar.

In S303, intermediate avatar data is determined based on basic avatar data, the current rotation factor and the current scaling factor.

The current rotation factor and the current scaling factor may be data updated in the previous iteration process. The current iteration factor and the current scaling factor in the first iteration process may be determined by a skilled person according to needs or empirical values. For example, the current rotation factor and the current scaling factor may be each set to a unit matrix or a random matrix.

In S304, weighted enhancement of the intermediate avatar data, weighted enhancement of the target avatar data and weighted enhancement of the basic avatar data are performed through the skin weight so that intermediate avatar enhancement data, target avatar enhancement data and basic avatar enhancement data are obtained.

In the process of determining the target scaling factor, after weighted enhancement of the intermediate avatar data and weighted enhancement of the target avatar data are performed through the skin weight, weighted enhancement of the basic avatar data is required so that the basic avatar enhancement data is obtained. In this manner, when the current scaling factor is determined subsequently, data types are consistent, and thus low accuracy of the finally determined target scaling factor caused by inconsistent data types is avoided.

In an embodiment, weighted processing of the point cloud data of each corresponding skin vertex in the basic avatar data is performed through the skin weight of each skin vertex so that the basic avatar enhancement data is obtained.

In S305, the current rotation factor is updated based on the intermediate avatar enhancement data and the target avatar enhancement data.

In S306, rotation processing of the target avatar enhancement data is performed based on the current rotation factor.

Rotation processing of the target avatar enhancement data is performed based on the current rotation factor so that the impact of rotation from the intermediate avatar enhancement data to the target avatar enhancement data is eliminated, and the current scaling factor associated with the scaling operation is determined directly.

In S307, the current scaling factor is updated based on the rotation processing result and the basic avatar enhancement data.

The impact of the rotation operation is eliminated from the rotation processing result. Therefore, the data scaling result is determined based on only the rotation processing result and the basic avatar enhancement data, and the currently determined data scaling result is used as the current scaling factor to facilitate determination of the intermediate avatar data in the next iteration process.

In an optional embodiment, to eliminate the impact of other bone nodes on the skin vertex of the current bone node to improve the accuracy of the determination result of the current scaling factor, it is feasible to determine the weighted root-mean-square error of the rotation processing result and the weighted root-mean-square error of the basic avatar enhancement data based on the skin weight; and update the current scaling factor based on the ratio of the weighted root-mean-square error of the rotation processing result to the weighted root-mean-square error of the basic avatar enhancement data.

The weighted root-mean-square error of the rotation processing result and the weighted root-mean-square error of the basic avatar enhancement data are determined based on the skin weight; the ratio of the weighted root-mean-square error of the rotation processing result to the weighted root-mean-square error of the basic avatar enhancement data is determined; and a diagonal matrix is constructed based on the ratio, and the constructed diagonal matrix is used as the updated current scaling factor.

It is to be understood that the skin weight is introduced in the process of determining the root-mean-square error so that the impact of other bone nodes on the scaling process of the skin vertex of the current bone node is eliminated through the determined weighted root-mean-square error. In this manner, the accuracy of the determination result of the current scaling factor is improved, laying a foundation for the accuracy of the determined target scaling factor.

In S308, when an iteration termination condition is satisfied, the current rotation factor is used as the target rotation factor and the current scaling factor is used as the target scaling factor.

In S309, the skinned mesh model is driven based on the bone driving factor of each bone node, including the target rotation factor and the target scaling factor.

Exemplarily, the target bone driving factor is determined based on the product of the target scaling factor and the target rotation factor; and the skinned mesh model is driven based on the target bone driving factor so that the scaling operation and rotation operation of the basic avatar data are implemented and thereby data identical to or similar to the target avatar data is obtained for rendering of the avatar so that the avatar imitates information such as expression and/or gesture information in the picture to be converted. In this manner, the final avatar data is obtained.

In this embodiment of the present application, in the process of iteratively determining the current rotation factor, rotation processing of the target avatar enhancement data is performed through the current rotation factor, eliminating the impact of the rotation operation in the process of converting the basic avatar data into the target avatar data. Then, the current scaling factor is determined based on the rotation processing result and the basic avatar enhancement data. In this manner, the accuracy of the determination result of the current scaling factor is improved, and thus the accuracy of the determination result of the target scaling factor is improved.

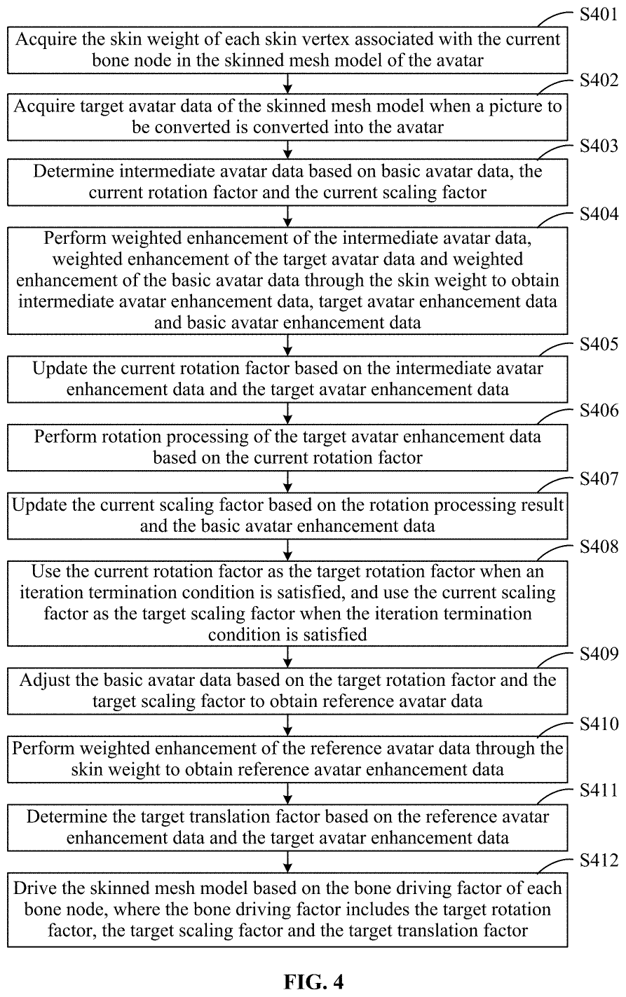

Exemplarily, the bone driving factor may further include a target translation factor. In an optional embodiment of the present application, the generation mechanism of the target translation factor is optimized and improved. FIG. 4 is a flowchart of a driving method of an avatar. With further reference to FIG. 4, the method includes the steps below.

In S401, the skin weight of each skin vertex associated with the current bone node in the skinned mesh model of the avatar is acquired.

In S402, target avatar data of the skinned mesh model is acquired when a picture to be converted is converted into the avatar.

In S403, intermediate avatar data is determined based on basic avatar data, the current rotation factor and the current scaling factor.

In S404, weighted enhancement of the intermediate avatar data, weighted enhancement of the target avatar data and weighted enhancement of the basic avatar data are performed through the skin weight so that intermediate avatar enhancement data, target avatar enhancement data and basic avatar enhancement data are obtained.

In S405, the current rotation factor is updated based on the intermediate avatar enhancement data and the target avatar enhancement data.

In S406, rotation processing of the target avatar enhancement data is performed based on the current rotation factor.

In S407, the current scaling factor is updated based on the rotation processing result and the basic avatar enhancement data.

In S408, when an iteration termination condition is satisfied, the current rotation factor is used as the target rotation factor and the current scaling factor is used as the target scaling factor.

In S409, the basic avatar data is adjusted based on the target rotation factor and the target scaling factor so that reference avatar data is obtained.

Exemplarily, the scaling operation of the basic avatar data is performed using the target scaling factor, and the rotation operation of the scaling result is performed using the target rotation factor. In this manner, the reference avatar data is obtained. It is to be understood that the scaling operation and the rotation operation which are performed sequentially on the basic avatar data eliminate the impact of scaling and rotation in the translation process, laying a foundation for a more accurate target translation factor.

In S410, weighted enhancement of the reference avatar data is performed through the skin weight so that reference avatar enhancement data is obtained.

Exemplarily, the point cloud data of each skin vertex in the reference avatar data is weighted through the skin weights so that the reference avatar enhancement data is obtained. In this manner, the impact of other bone nodes on the skin vertex associated with the current bone node is eliminated.

In S411, the target translation factor is determined based on the reference avatar enhancement data and the target avatar enhancement data.

Exemplarily, the difference between the target avatar enhancement data and the reference avatar enhancement data is determined and used as the target translation factor.

In S412, the skinned mesh model is driven based on the bone driving factor of each bone node, where the bone driving factor includes the target rotation factor, the target scaling factor and the target translation factor.

Exemplarily, the target bone driving factor is determined based on the product of the target scaling factor, the target rotation factor and the target translation factor; and the skinned mesh model is driven based on the target bone driving factor so that the scaling operation, rotation operation and translation operation of the basic avatar data are implemented and thereby data identical to or similar to the target avatar data is obtained for rendering of the avatar so that the avatar imitates information such as expression and/or gesture information in the picture to be converted. In this manner, the final avatar data is obtained.

In this embodiment of the present application, the target translation factor is determined after the iteration is completed so that the data calculation amount of the process of determining the target translation factor is simplified. Moreover, in the process of determining the target translation factor, weighted enhancement of the reference avatar data is performed through the skin weight so that the reference avatar enhancement data is obtained, eliminating the impact of the rotation operation and scaling operation. Then, the target translation factor is determined based on the reference avatar enhancement data and the target avatar enhancement data so that the accuracy of the determination result of the target translation factor is improved.

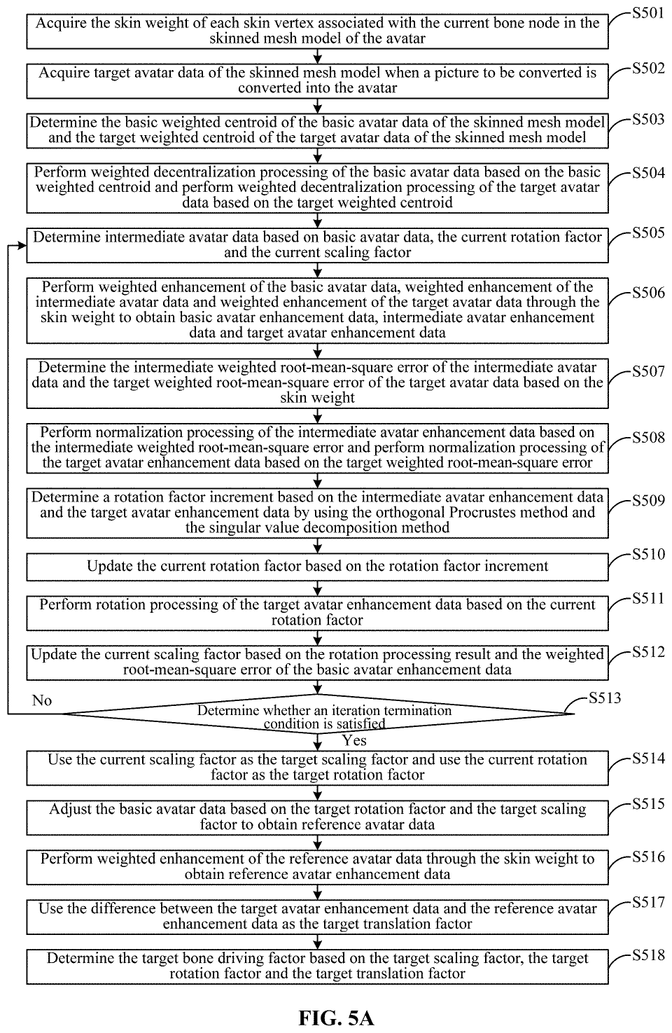

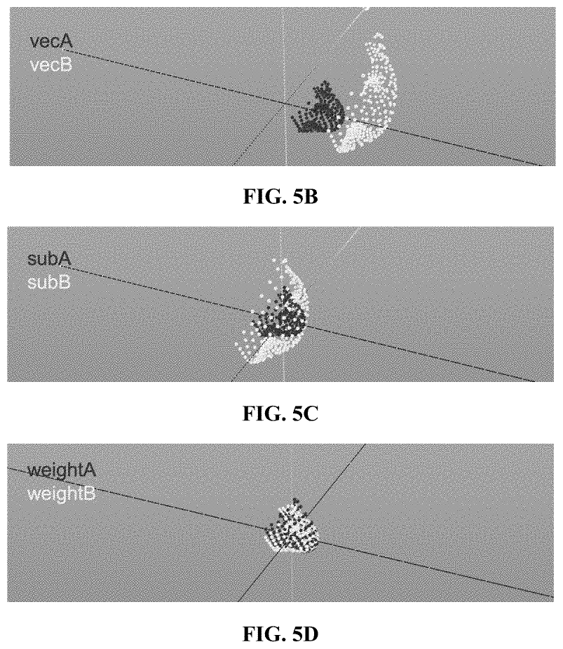

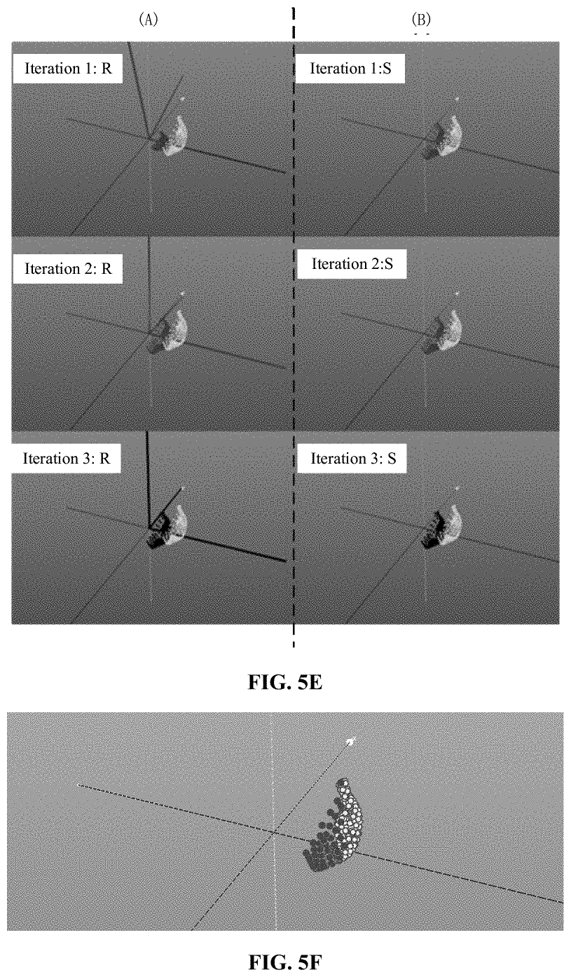

Based on each preceding solution, the present application further provides a preferred embodiment for implementation of a driving method of an avatar. FIG. 5A is a flowchart of a driving method of an avatar. The method includes the steps below.

In S501, the skin weight of each skin vertex associated with the current bone node in the skinned mesh model of the avatar is acquired.

In S502, target avatar data of the skinned mesh model is acquired when a picture to be converted is converted into the avatar.

In S503, the basic weighted centroid of the basic avatar data of the skinned mesh model and the target weighted centroid of the target avatar data of the skinned mesh model are determined.

Exemplarily, the basic weighted centroid and the target weighted centroid may be determined using the formulas below.

$$\{ \begin{matrix}weightCentre A = {\sum }_{i = 0}^{n} {A}_{i} * {weight}_{i} \\ weightCentre B = {\sum }_{i = 0}^{n} {B}_{i} * {weight}_{i}\end{matrix}$$

weightCentreA denotes the basic weighted centroid. weightCentreB denotes the target weighted centroid. Aᵢ denotes the position data of the ith skin vertex of the current bone node in the basic avatar data. Bᵢ denotes the position data of the ith skin vertex of the current bone node in the target avatar data. weightᵢ denotes the skin weight of the ith skin vertex. n+1 denotes the total number of skin vertexes associated with the current bone node.

In S504, weighted decentralization processing of the basic avatar data is performed based on the basic weighted centroid so that the basic avatar data is updated, and weighted decentralization processing of the target avatar data is performed based on the target weighted centroid so that the target avatar data is updated.

Exemplarily, weighted decentralization processing of the basic avatar data and weighted decentralization processing of the target avatar data may be performed using the formulas below.

$$\{ \begin{matrix}subA = vecA - weightCentre A \\ subB = vecB - weightCentre B\end{matrix}$$

vecA denotes the basic avatar data. subA denotes weighted-decentralized basic avatar data. vecB denotes the target avatar data. subB denotes weighted-decentralized target avatar data.

FIG. 5B is a diagram illustrating the point cloud data of the basic avatar data and the target avatar data of a skin vertex associated with the tip of a face's nose. In FIG. 5B, point cloud data of a darker color corresponds to the basic avatar data vecA, and point cloud data of a lighter color corresponds to the target avatar data vecB.

FIG. 5C is a diagram of weighted-decentralized avatar data. In FIG. 5C, point cloud data of a darker color corresponds to subA, and point cloud data of a lighter color corresponds to subB.

In S505, intermediate avatar data is determined based on basic avatar data, the current rotation factor and the current scaling factor.

Exemplarily, the intermediate avatar data may be determined using the formula below.

vecA′=subA*matScale*matRotation

vecA′ denotes the intermediate avatar data. matScale denotes the current scaling factor. matRotation denotes the current rotation factor.

In S506, weighted enhancement of the basic avatar data, weighted enhancement of the intermediate avatar data and weighted enhancement of the target avatar data are performed through the skin weight so that basic avatar enhancement data, intermediate avatar enhancement data and target avatar enhancement data are obtained.

Exemplarily, weighted enhancement of the avatar data may be determined using the formulas below.

$$\{ \begin{matrix}{weight A}_{i} = {subA}_{i} * {weight}_{i} \\ {{weight A}^{′}}_{i} = {{vecA}^{′}}_{i} * {weight}_{i} \\ weight B = {subA}_{i} * {weight}_{i}\end{matrix}$$

subAᵢ denotes decentralized basic avatar data. vecA′ᵢ denotes intermediate avatar data. subBᵢ denotes decentralized target avatar data. Position data weightAᵢ, weightA′ᵢ and weightBᵢ of the ith skin vertex of the current bone node are the position data of the ith skin vertex of the current bone node in the basic avatar enhancement data weightA, the position data of the ith skin vertex of the current bone node in the intermediate avatar enhancement data weightA′ and the position data of the ith skin vertex of the current bone node in the target avatar enhancement data weightB respectively.

FIG. 5D is a diagram of avatar enhancement data. FIG. 5D includes the basic avatar enhancement data weightA (point cloud data of a darker color in FIG. 5D) obtained from weighted enhancement and the target avatar enhancement data weightB (point cloud data of a lighter color in FIG. 5D) obtained from weighted enhancement.

In S507, the intermediate weighted root-mean-square error of the intermediate avatar data and the target weighted root-mean-square error of the target avatar data are determined based on the skin weight.

Exemplarily, the weighted root-mean-square errors may be determined using the formulas below.

$$\{ \begin{matrix}std ( {weight A}^{′} ) = \sqrt{\frac{{\sum }_{i = 0}^{n} {( {weight}_{i} * {{vecA}^{′}}_{i} )}^{2}}{{\sum }_{i = 0}^{n} {weight}_{i}}} \\ std ( weight B ) = \sqrt{\frac{{\sum }_{i = 0}^{n} {( {weight}_{i} * {vecB}_{i} )}^{2}}{{\sum }_{i = 0}^{n} {weight}_{i}}}\end{matrix}$$

std(weightA) denotes the intermediate weighted root-mean-square error. std(weightB) denotes the target weighted root-mean-square error.

In S508, normalization processing of the intermediate avatar enhancement data is performed based on the intermediate weighted root-mean-square error so that the intermediate avatar enhancement data is updated, and normalization processing of the target avatar enhancement data is performed based on the target weighted root-mean-square error so that the target avatar enhancement data is updated.

Exemplarily, the normalization processing may be performed using the formulas below.

$$\{ \begin{matrix}{norA}^{′} = {weight A}^{′} / std ( {weight A}^{′} ) \\ norB = weight B / std ( weight B )\end{matrix}$$

norA′ denotes normalized intermediate avatar enhancement data. norB denotes normalized target avatar enhancement data.

In S509, a rotation factor increment is determined based on the intermediate avatar enhancement data and the target avatar enhancement data by using the orthogonal Procrustes method and the singular value decomposition method.

Exemplarily, the rotation factor increment may be determined using the formulas below.

$$\{ \begin{matrix}U , S , V = matRotation * ( {norA}^{′ T} * norB ) \\ ΔRotation = U * {V}^{T}\end{matrix}$$

ΔRotation denotes the rotation factor increment.

In S510, the current rotation factor is updated based on the rotation factor increment.

Exemplarily, the current rotation factor may be updated using the formula below.

matRotation=matRotation*ΔRotation

In S511, rotation processing of the target avatar enhancement data is performed based on the current rotation factor.

Exemplarily, rotation processing of the target avatar enhancement data may be performed using the formula below.

projB=weightB*matRotation^{T}

projB denotes the rotation processing result of the target avatar enhancement data weightB.

In S512, the current scaling factor is updated based on the rotation processing result and the weighted root-mean-square error of the basic avatar enhancement data.

Exemplarily, the current scaling factor may be updated using the formula below.

$$\{ \begin{matrix}std ( projB ) = \sqrt{\frac{{\sum }_{i = 0}^{n} {( {weight}_{i} * {projB}_{i} )}^{2}}{{\sum }_{i = 0}^{n} {weight}_{i}}} \\ matScale = diag ( std ( projB ) / std ( weight A ) )\end{matrix}$$

std(projB) denotes the weighted root-mean-square error of the rotation processing result. matScale denotes the current scaling factor.

In S513, it is determined whether an iteration termination condition is satisfied; if yes, S514 is performed; otherwise, S505 is performed.

In an embodiment, the iteration termination condition may be satisfied in the following manner: The error between the intermediate avatar enhancement data and the target avatar enhancement data is less than a set error value. Alternatively, the error between the intermediate avatar enhancement data and the target avatar enhancement data in the iteration process tends to be stable. Alternatively, the number of iterations of the target rotation factor satisfies the set threshold of the number of iterations. The set error value or the set threshold of the number of iterations may be set by a skilled person according to needs or an empirical value or may be repeatedly determined or adjusted through a large number of experiments.

In S514, the current scaling factor is used as the target scaling factor, and the current rotation factor is used as the target rotation factor.

FIG. 5E is a diagram illustrating the iteration result of three iterations. In FIG. 5E, FIG. (A) is a diagram illustrating the iteration result corresponding to the current rotation factor (R), and FIG. (B) is a diagram illustrating the iteration result corresponding to the scaling rotation factor (S). In FIG. 5E, point cloud data of a darker color is the intermediate avatar data, and point cloud data of a lighter color is the target avatar data. As can be seen from FIG. 5E, as the number of iterations increases, the intermediate point cloud avatar data determined based on the current rotation factor (R) and the current scaling factor (S) is gradually approximate to the target point cloud avatar data.

In S515, the basic avatar data is adjusted based on the target rotation factor and the target scaling factor so that reference avatar data is obtained.

Exemplarily, the reference avatar data may be determined using the formula below.

vecA″=vecA*Scale*Rotation

vecA″ denotes the reference avatar data. Scale denotes the target scaling factor. Rotation denotes the target rotation factor.

In S516, weighted enhancement of the reference avatar data is performed through the skin weight so that reference avatar enhancement data is obtained.

Exemplarily, the reference avatar enhancement data may be determined using the formula below.

weightA″ᵢ=vecA″ᵢ*weightᵢ

weightA″ᵢ denotes the position data of the reference avatar enhancement data at the ith skin vertex.

In S517, the difference between the target avatar enhancement data and the reference avatar enhancement data is used as the target translation factor.

Exemplarily, the target translation factor may be determined using the formula below.

Translate=weightB−weightA″

Translate denotes the target translation factor. weightA″ denotes the reference avatar enhancement data.

In S518, the target bone driving factor is determined based on the target scaling factor, the target rotation factor and the target translation factor for driving of the skinned mesh model so that the avatar corresponding to the picture to be converted is obtained.

Exemplarily, the target bone driving factor may be obtained using the formula below.

Rigid=Scale*Rotation*Translate

Rigid denotes the target bone driving factor.

FIG. 5F is a diagram of a rigid transformation result. Referring to FIG. 5F, the skinned mesh model is driven through the target bone driving factor so that the basic avatar data is rigidity transformed. As can be seen from the result illustrated in FIG. 5F, the rigid transformation result (point cloud data of a darker color) highly matches the target avatar data (point cloud data of a lighter color).

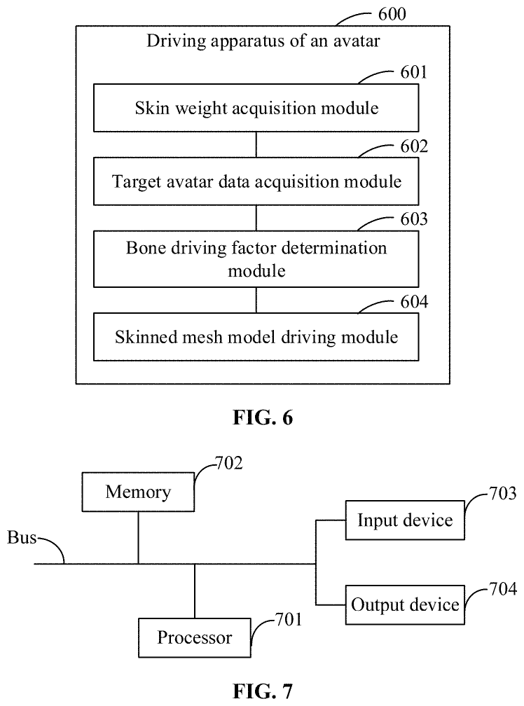

The present application further provides an embodiment of an apparatus for performing each preceding driving method of an avatar. In an embodiment, referring to FIG. 6, a driving apparatus 600 of an avatar includes a skin weight acquisition module 601, a target avatar data acquisition module 602, a bone driving factor determination module 603 and a skinned mesh model driving module 604.

The skin weight acquisition module 601 is configured to acquire the skin weight of each skin vertex associated with the current bone node in the skinned mesh model of the avatar.

The target avatar data acquisition module 602 is configured to acquire target avatar data of the skinned mesh model when a picture to be converted is converted into the avatar.

The bone driving factor determination module 603 is configured to determine the bone driving factor of the skinned mesh model based on the skin weight, basic avatar data of the skinned mesh model and the target avatar data.

The skinned mesh model driving module 604 is configured to drive the skinned mesh model based on the bone driving factor of each bone node.

In this embodiment of the present application, the skin weight of each skin vertex associated with the current bone node is adopted in the process of determining the bone driving factor, and the impact of other bone nodes on the skin vertex associated with the current bone node is eliminated by the skin weight. In this manner, the accuracy of the determination result of the bone driving factor of the current bone node is improved, and thus the degree of matching between the target avatar data and the driving result of driving the avatar based on the bone driving factor is improved.

In an embodiment, the bone driving factor includes a target rotation factor.

The bone driving factor determination module 603 includes an intermediate avatar data determination unit, a weighted enhancement unit, a current rotation factor updating unit and a target rotation factor determination unit.

The intermediate avatar data determination unit is configured to determine intermediate avatar data based on the basic avatar data and the current rotation factor.

The weighted enhancement unit is configured to perform weighted enhancement of the intermediate avatar data and weighted enhancement of the target avatar data through the skin weight to obtain intermediate avatar enhancement data and target avatar enhancement data.

The current rotation factor updating unit is configured to update the current rotation factor based on the intermediate avatar enhancement data and the target avatar enhancement data.

The target rotation factor determination unit is configured to use the current rotation factor as the target rotation factor when an iteration termination condition is satisfied.

In an embodiment, the bone driving factor determination module 603 further includes a decentralization processing unit.

The decentralization processing unit is configured to, before the intermediate avatar data is determined based on the basic avatar data and the current rotation factor, perform decentralization processing of the basic avatar data and decentralization processing of the target avatar data to update the basic avatar data and the target avatar data.

In an embodiment, the decentralization processing unit includes a weighted centroid determination subunit and a decentralization processing subunit.

The weighted centroid determination subunit is configured to determine the basic weighted centroid of the basic avatar data and the target weighted centroid of the target avatar data based on the skin weight.

The decentralization processing subunit is configured to perform decentralization processing of the basic avatar data based on the basic weighted centroid and perform decentralization processing of the target avatar data based on the target weighted centroid.

In an embodiment, the bone driving factor determination module 603 further includes a normalization processing unit.

The normalization processing unit is configured to, before the current rotation factor is updated based on the intermediate avatar enhancement data and the target avatar enhancement data, perform normalization processing of the intermediate avatar enhancement data and normalization processing of the target avatar enhancement data to update the intermediate avatar enhancement data and the target avatar enhancement data; or perform normalization processing of the intermediate avatar data and normalization processing of the target avatar data to update the intermediate avatar data and the target avatar data.

In an embodiment, the normalization processing unit includes a weighted root-mean-square error determination subunit and a first normalization processing subunit.

The weighted root-mean-square error determination subunit is configured to determine the intermediate weighted root-mean-square error of the intermediate avatar data and the target weighted root-mean-square error of the target avatar data based on the skin weight.

The first normalization processing subunit is configured to perform normalization processing of the intermediate avatar enhancement data based on the intermediate weighted root-mean-square error and perform normalization processing of the target avatar enhancement data based on the target weighted root-mean-square error.

In an embodiment, the normalization processing unit includes a weighted root-mean-square error determination subunit and a second normalization processing subunit.

The weighted root-mean-square error determination subunit is configured to determine the intermediate weighted root-mean-square error of the intermediate avatar data and the target weighted root-mean-square error of the target avatar data based on the skin weight.

The second normalization processing subunit is configured to perform normalization processing of the intermediate avatar data based on the intermediate weighted root-mean-square error and perform normalization processing of the target avatar data based on the target weighted root-mean-square error.

In an embodiment, the bone driving factor further includes a target scaling factor.

The intermediate avatar data determination unit includes an intermediate avatar data determination subunit.

The intermediate avatar data determination subunit is configured to determine the intermediate avatar data based on the basic avatar data, the current rotation factor and the current scaling factor.

The weighted enhancement unit is further configured to perform weighted enhancement of the basic avatar data based on the skin weight to obtain basic avatar enhancement data.

The bone driving factor determination module 603 further includes a rotation processing unit, a current scaling factor updating unit and a target scaling factor determination unit.

The rotation processing unit is configured to, after the current rotation factor is updated based on the intermediate avatar enhancement data and the target avatar enhancement data and before the current rotation factor is used as the target rotation factor when the iteration termination condition is satisfied, perform rotation processing of the target avatar enhancement data based on the current rotation factor.

The current scaling factor updating unit is configured to update the current scaling factor based on the rotation processing result and the basic avatar enhancement data.

The target scaling factor determination unit is configured to use the current scaling factor as the target scaling factor when the iteration termination condition is satisfied.

In an embodiment, the rotation processing unit includes a weighted root-mean-square error determination subunit and a current scaling factor updating subunit.

The weighted root-mean-square error determination subunit is configured to determine the weighted root-mean-square error of the rotation processing result and the weighted root-mean-square error of the basic avatar enhancement data based on the skin weight.

The current scaling factor updating subunit is configured to update the current scaling factor based on the ratio of the weighted root-mean-square error of the rotation processing result to the weighted root-mean-square error of the basic avatar enhancement data.

In an embodiment, the bone driving factor further includes a target translation factor.

The bone driving factor determination module 603 further includes a reference avatar data obtaining unit, a reference avatar enhancement data obtaining unit and a target translation factor determination unit.

The reference avatar data obtaining unit is configured to adjust the basic avatar data based on the target rotation factor and the target scaling factor to obtain reference avatar data.

The reference avatar enhancement data obtaining unit is configured to perform weighted enhancement of the reference avatar data through the skin weight to obtain reference avatar enhancement data.

The target translation factor determination unit is configured to determine the target translation factor based on the reference avatar enhancement data and the target avatar enhancement data.

The driving apparatus of an avatar may perform the driving method of an avatar provided in any embodiment of the present disclosure and may have function modules and beneficial effects corresponding to the driving method of an avatar.

According to an embodiment of the present application, the present application further provides an electronic device and a readable storage medium.

FIG. 7 is a block diagram of an electronic device for performing a driving method of an avatar according to an embodiment of the present application. Electronic devices are intended to represent various forms of digital computers, for example, laptop computers, desktop computers, worktables, personal digital assistants, servers, blade servers, mainframe computers and other applicable computers. Electronic devices may also represent various forms of mobile devices, for example, personal digital assistants, cellphones, smartphones, wearable devices and other similar computing devices. Herein the shown components, the connections and relationships between these components, and the functions of these components are illustrative only and are not intended to limit the implementation of the present application as described and/or claimed herein.

As shown in FIG. 7, the electronic device includes one or more processors 701, a memory 702, and interfaces for connecting components, including a high-speed interface and a low-speed interface. The components are interconnected to each other by different buses and may be mounted on a common mainboard or in other manners as desired. The processor may process instructions executed in the electronic device, including instructions stored in or on the memory to make graphic information of a GUI displayed on an external input/output device (for example, a display device coupled to an interface). In other embodiments, if required, multiple processors and/or multiple buses may be used with multiple memories. Similarly, multiple electronic devices may be connected, each providing some necessary operations (for example, a server array, a set of blade servers or a multi-processor system). FIG. 7 shows one processor 701 by way of example.

The memory 702 is the non-transitory computer-readable storage medium provided in the present application. The memory stores instructions executable by at least one processor to cause the at least one processor to perform the driving method of an avatar provided in the present application. The non-transitory computer-readable storage medium of the present application stores computer instructions for causing a computer to perform the driving method of an avatar provided in the present application.

The memory 702 as a non-transitory computer-readable storage medium is configured to store a non-transitory software program, a non-transitory computer-executable program, and modules, for example, program instructions/modules corresponding to the driving method of an avatar provided in embodiments of the present application (for example, the skin weight acquisition module 601, the target avatar data acquisition module 602, the bone driving factor determination module 603 and the skinned mesh model driving module 604 shown in FIG. 6). The processor 701 executes non-transitory software programs, instructions and modules stored in the memory 702 to execute the various function applications and data processing of a server, that is, implement the driving method of an avatar provided in the preceding method embodiments.

The memory 702 may include a program storage region and a data storage region. The program storage region may store an operating system and an application program required by at least one function. The data storage region may store data created based on the use of the electronic device for performing the driving method of an avatar. Additionally, the memory 702 may include a high-speed random-access memory and a non-transient memory, for example, at least one disk memory, a flash memory or another non-transient solid-state memory. In some embodiments, the memory 702 optionally includes memories disposed remote from the processor 701, and these remote memories may be connected, through a network, to the electronic device for performing the driving method of an avatar. Examples of the preceding network include, but are not limited to, the Internet, an intranet, a local area network, a mobile communication network and a combination thereof.

The electronic device for performing the driving method of an avatar may further include an input device 703 and an output device 704. The processor 701, the memory 702, the input device 703 and the output device 704 may be connected by a bus or in other manners. FIG. 7 uses connection by a bus as an example.

The input device 703 can receive input number or character information and generate key signal input related to user settings and function control of the electronic device for performing the driving method of an avatar. The input device 403 may be, for example, a touchscreen, a keypad, a mouse, a trackpad, a touchpad, a pointing stick, one or more mouse buttons, a trackball or a joystick. The output device 704 may be, for example, a display device, an auxiliary lighting device (for example, an LED) or a haptic feedback device (for example, a vibration motor). The display device may include, but is not limited to, a liquid-crystal display (LCD), a light-emitting diode (LED) display or a plasma display. In some embodiments, the display device may be a touchscreen.

The various embodiments of the systems and techniques described herein may be implemented in digital electronic circuitry, integrated circuitry, an application-specific integrated circuit (ASIC), computer hardware, firmware, software and/or a combination thereof. The various embodiments may include implementations in one or more computer programs. The one or more computer programs are executable and/or interpretable on a programmable system including at least one programmable processor. The programmable processor may be a dedicated or general-purpose programmable processor for receiving data and instructions from a memory system, at least one input device and at least one output device and transmitting the data and instructions to the memory system, the at least one input device and the at least one output device.

These computing programs (also referred to as programs, software, software applications or codes) include machine instructions of a programmable processor. These computing programs may be implemented in a high-level procedural and/or object-oriented programming language and/or in an assembly/machine language. As used herein, the term “machine-readable medium” or “computer-readable medium” refers to any computer program product, device and/or apparatus (for example, a magnetic disk, an optical disk, a memory or a programmable logic device (PLD)) for providing machine instructions and/or data for a programmable processor, including a machine-readable medium for receiving machine instructions as machine-readable signals. The term “machine-readable signal” refers to any signal used in providing machine instructions and/or data for a programmable processor.

In order that interaction with a user is provided, the systems and techniques described herein may be implemented on a computer. The computer has a display device (for example, a cathode-ray tube (CRT) or liquid-crystal display (LCD) monitor) for displaying information to the user; and a keyboard and a pointing device (for example, a mouse or a trackball) through which the user can provide input to the computer. Other types of devices may also be used for providing interaction with a user. For example, feedback provided for the user may be sensory feedback in any form (for example, visual feedback, auditory feedback or haptic feedback). Moreover, input from the user may be received in any form (including acoustic input, voice input or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein) or a computing system including any combination of such back-end, middleware or front-end components. The components of the system may be interconnected by any form or medium of digital data communication (for example, a communication network). Examples of the communication network include a local area network (LAN), a wide area network (WAN), the Internet and a blockchain network.

The computing system may include clients and servers. A client and a server are generally remote from each other and typically interact through a communication network. The relationship between the client and the server arises by virtue of computer programs running on the respective computers and having a client-server relationship to each other. The server may be a cloud server, also referred to as a cloud computing server or a cloud host. As a host product in a cloud computing service system, the server solves the defects of difficult management and weak service scalability in a related physical host and a related VPS service.

With the solution of this embodiment of the present application, the skin weight of each skin vertex associated with the current bone node is adopted in the process of determining the bone driving factor, and the impact of other bone nodes on the skin vertex associated with the current bone node is eliminated by the skin weight. In this manner, the accuracy of the determination result of the bone driving factor of the current bone node is improved, and thus the degree of matching between the target avatar data and the driving result of driving the avatar based on the bone driving factor is improved.

It is to be understood that various forms of the preceding flows may be used, with steps reordered, added or removed. For example, the steps described in the present application may be executed in parallel, in sequence or in a different order as long as the desired result of the technical solution disclosed in the present application is achieved. The execution sequence of these steps is not limited herein.

The scope of the present application is not limited to the preceding embodiments. It is to be understood by those skilled in the art that various modifications, combinations, subcombinations and substitutions may be made depending on design requirements and other factors. Any modifications, equivalent substitutions, improvements and the like made within the spirit and principle of the present application are within the scope of the present application.

What is claimed is:

1. A driving method of an avatar, comprising:
acquiring a skin weight of each vertex associated with a current bone node in a skinned mesh model of the avatar;
acquiring target avatar data of the skinned mesh model when a picture to be converted is converted into the avatar;
determining a bone driving factor of the current bone node based on the skin weight, basic avatar data of the skinned mesh model and the target avatar data;
repeatedly performing the steps from acquiring the skin weight of each vertex associated with the current bone node in the skinned mesh model of the avatar to determining the bone driving factor of the current bone node based on the skin weight, the basic avatar data of the skinned mesh model and the target avatar data so as to determine bone driving factors of a plurality of bone nodes of the skinned mesh model; and
driving the skinned mesh model based on the bone driving factors of the plurality of bone nodes.

2. The method according to claim 1, wherein the bone driving factor comprises a target rotation factor; and
determining the bone driving factor of the current bone node based on the skin weight, the basic avatar data of the skinned mesh model and the target avatar data comprises:
determining intermediate avatar data based on the basic avatar data and a current rotation factor;
performing weighted enhancement of the intermediate avatar data and weighted enhancement of the target avatar data through the skin weight to obtain intermediate avatar enhancement data and target avatar enhancement data;
updating the current rotation factor based on the intermediate avatar enhancement data and the target avatar enhancement data; and
using the current rotation factor as the target rotation factor when an iteration termination condition is satisfied.

3. The method according to claim 2, before determining the intermediate avatar data based on the basic avatar data and the current rotation factor, the method further comprising:
performing decentralization processing of the basic avatar data and decentralization processing of the target avatar data to update the basic avatar data and the target avatar data.

4. The method according to claim 3, wherein performing decentralization processing of the intermediate avatar enhancement data and the decentralization processing of the target avatar data comprises:
determining a basic weighted centroid of the basic avatar data and a target weighted centroid of the target avatar data based on the skin weight; and
performing decentralization processing of the basic avatar data based on the basic weighted centroid and performing decentralization processing of the target avatar data based on the target weighted centroid.

5. The method according to claim 2, before updating the current rotation factor based on the intermediate avatar enhancement data and the target avatar enhancement data, the method further comprising:
performing normalization processing of the intermediate avatar enhancement data and normalization processing of the target avatar enhancement data to update the intermediate avatar enhancement data and the target avatar enhancement data; or
performing normalization processing of the intermediate avatar data and normalization processing of the target avatar data to update the intermediate avatar data and the target avatar data.

6. The method according to claim 5, wherein performing the normalization processing of the intermediate avatar enhancement data and the normalization processing of the target avatar enhancement data to update the intermediate avatar enhancement data and the target avatar enhancement data comprises:
determining an intermediate weighted root-mean-square error of the intermediate avatar data and a target weighted root-mean-square error of the target avatar data based on the skin weight; and
performing normalization processing of the intermediate avatar enhancement data based on the intermediate weighted root-mean-square error and performing normalization processing of the target avatar enhancement data based on the target weighted root-mean-square error.

7. The method according to claim 5, wherein performing the normalization processing of the intermediate avatar data and the normalization processing of the target avatar data to update the intermediate avatar data and the target avatar data comprises:
determining an intermediate weighted root-mean-square error of the intermediate avatar data and a target weighted root-mean-square error of the target avatar data based on the skin weight; and
performing normalization processing of the intermediate avatar data based on the intermediate weighted root-mean-square error and performing normalization processing of the target avatar data based on the target weighted root-mean-square error.

8. The method according to claim 2, wherein the bone driving factor further comprises a target scaling factor;
determining the intermediate avatar data based on the basic avatar data and the current rotation factor comprises:
determining the intermediate avatar data based on the basic avatar data, the current rotation factor and a current scaling factor; and
after updating the current rotation factor based on the intermediate avatar enhancement data and the target avatar enhancement data and before using the current rotation factor as the target rotation factor when the iteration termination condition is satisfied, the method further comprises:
performing weighted enhancement of the basic avatar data based on the skin weight to obtain basic avatar enhancement data;
performing rotation processing of the target avatar enhancement data based on the current rotation factor;
updating the current scaling factor based on a rotation processing result and the basic avatar enhancement data; and
using the current scaling factor as the target scaling factor when the iteration termination condition is satisfied.

9. The method according to claim 3, wherein the bone driving factor further comprises a target scaling factor;
determining the intermediate avatar data based on the basic avatar data and the current rotation factor comprises:
determining the intermediate avatar data based on the basic avatar data, the current rotation factor and a current scaling factor; and
after updating the current rotation factor based on the intermediate avatar enhancement data and the target avatar enhancement data and before using the current rotation factor as the target rotation factor when the iteration termination condition is satisfied, the method further comprises:
performing weighted enhancement of the basic avatar data based on the skin weight to obtain basic avatar enhancement data;
performing rotation processing of the target avatar enhancement data based on the current rotation factor;
updating the current scaling factor based on a rotation processing result and the basic avatar enhancement data; and
using the current scaling factor as the target scaling factor when the iteration termination condition is satisfied.

10. The method according to claim 4, wherein the bone driving factor further comprises a target scaling factor;
determining the intermediate avatar data based on the basic avatar data and the current rotation factor comprises:
determining the intermediate avatar data based on the basic avatar data, the current rotation factor and a current scaling factor; and
after updating the current rotation factor based on the intermediate avatar enhancement data and the target avatar enhancement data and before using the current rotation factor as the target rotation factor when the iteration termination condition is satisfied, the method further comprises:
performing weighted enhancement of the basic avatar data based on the skin weight to obtain basic avatar enhancement data;
performing rotation processing of the target avatar enhancement data based on the current rotation factor;
updating the current scaling factor based on a rotation processing result and the basic avatar enhancement data; and
using the current scaling factor as the target scaling factor when the iteration termination condition is satisfied.

11. The method according to claim 5, wherein the bone driving factor further comprises a target scaling factor;
determining the intermediate avatar data based on the basic avatar data and the current rotation factor comprises:
determining the intermediate avatar data based on the basic avatar data, the current rotation factor and a current scaling factor; and
after updating the current rotation factor based on the intermediate avatar enhancement data and the target avatar enhancement data and before using the current rotation factor as the target rotation factor when the iteration termination condition is satisfied, the method further comprises:
performing weighted enhancement of the basic avatar data based on the skin weight to obtain basic avatar enhancement data;
performing rotation processing of the target avatar enhancement data based on the current rotation factor;
updating the current scaling factor based on a rotation processing result and the basic avatar enhancement data; and
using the current scaling factor as the target scaling factor when the iteration termination condition is satisfied.

12. The method according to claim 6, wherein the bone driving factor further comprises a target scaling factor;
determining the intermediate avatar data based on the basic avatar data and the current rotation factor comprises:
determining the intermediate avatar data based on the basic avatar data, the current rotation factor and a current scaling factor; and
after updating the current rotation factor based on the intermediate avatar enhancement data and the target avatar enhancement data and before using the current rotation factor as the target rotation factor when the iteration termination condition is satisfied, the method further comprises:
performing weighted enhancement of the basic avatar data based on the skin weight to obtain basic avatar enhancement data;
performing rotation processing of the target avatar enhancement data based on the current rotation factor;
updating the current scaling factor based on a rotation processing result and the basic avatar enhancement data; and
using the current scaling factor as the target scaling factor when the iteration termination condition is satisfied.

13. The method according to claim 7, wherein the bone driving factor further comprises a target scaling factor;
determining the intermediate avatar data based on the basic avatar data and the current rotation factor comprises:
determining the intermediate avatar data based on the basic avatar data, the current rotation factor and a current scaling factor; and
after updating the current rotation factor based on the intermediate avatar enhancement data and the target avatar enhancement data and before using the current rotation factor as the target rotation factor when the iteration termination condition is satisfied, the method further comprises:
performing weighted enhancement of the basic avatar data based on the skin weight to obtain basic avatar enhancement data;
performing rotation processing of the target avatar enhancement data based on the current rotation factor;
updating the current scaling factor based on a rotation processing result and the basic avatar enhancement data; and
using the current scaling factor as the target scaling factor when the iteration termination condition is satisfied.

14. The method according to claim 8, wherein updating the current scaling factor based on the rotation processing result and the basic avatar enhancement data comprises:
determining a weighted root-mean-square error of the rotation processing result and a weighted root-mean-square error of the basic avatar enhancement data based on the skin weight; and
updating the current scaling factor based on a ratio of the weighted root-mean-square error of the rotation processing result to the weighted root-mean-square error of the basic avatar enhancement data.

15. The method according to claim 8, wherein the bone driving factor further comprises a target translation factor; and the method further comprises:
adjusting the basic avatar data based on the target rotation factor and the target scaling factor to obtain reference avatar data;
performing weighted enhancement of the reference avatar data through the skin weight to obtain reference avatar enhancement data; and
determining the target translation factor based on the reference avatar enhancement data and the target avatar enhancement data.

16. An electronic device, comprising:
at least one processor; and
a memory communicatively connected to the at least one processor, wherein
the memory stores instructions executable by the at least one processor to cause the at least one processor to perform the following steps:
acquiring a skin weight of each vertex associated with a current bone node in a skinned mesh model of the avatar;
acquiring target avatar data of the skinned mesh model when a picture to be converted is converted into the avatar;
determining a bone driving factor of the current bone node based on the skin weight, basic avatar data of the skinned mesh model and the target avatar data;
repeatedly performing the steps from acquiring the skin weight of each vertex associated with the current bone node in the skinned mesh model of the avatar to determining the bone driving factor of the current bone node based on the skin weight, the basic avatar data of the skinned mesh model and the target avatar data so as to determine bone driving factors of a plurality of bone nodes of the skinned mesh model; and
driving the skinned mesh model based on the bone driving factors of the plurality of bone nodes.

17. The electronic device according to claim 16, wherein the bone driving factor comprises a target rotation factor; and
the memory stores instructions executable by the at least one processor to cause the at least one processor to determine the bone driving factor of the current bone node based on the skin weight, the basic avatar data of the skinned mesh model and the target avatar data by:
determining intermediate avatar data based on the basic avatar data and a current rotation factor;
performing weighted enhancement of the intermediate avatar data and weighted enhancement of the target avatar data through the skin weight to obtain intermediate avatar enhancement data and target avatar enhancement data;
updating the current rotation factor based on the intermediate avatar enhancement data and the target avatar enhancement data; and
using the current rotation factor as the target rotation factor when an iteration termination condition is satisfied.

18. The electronic device according to claim 17, the memory stores instructions executable by the at least one processor to cause the at least one processor to perform, before determining the intermediate avatar data based on the basic avatar data and the current rotation factor, the following step:
performing decentralization processing of the basic avatar data and decentralization processing of the target avatar data to update the basic avatar data and the target avatar data.

19. The electronic device according to claim 18, wherein the memory stores instructions executable by the at least one processor to cause the at least one processor to perform decentralization processing of the intermediate avatar enhancement data and the decentralization processing of the target avatar data by:
determining a basic weighted centroid of the basic avatar data and a target weighted centroid of the target avatar data based on the skin weight; and
performing decentralization processing of the basic avatar data based on the basic weighted centroid and performing decentralization processing of the target avatar data based on the target weighted centroid.

20. A non-transitory computer-readable storage medium storing computer instructions for causing a computer to perform the following steps:
acquiring a skin weight of each vertex associated with a current bone node in a skinned mesh model of the avatar;
acquiring target avatar data of the skinned mesh model when a picture to be converted is converted into the avatar;
determining a bone driving factor of the current bone node based on the skin weight, basic avatar data of the skinned mesh model and the target avatar data;
repeatedly performing the steps from acquiring the skin weight of each vertex associated with the current bone node in the skinned mesh model of the avatar to determining the bone driving factor of the current bone node based on the skin weight, the basic avatar data of the skinned mesh model and the target avatar data so as to determine bone driving factors of a plurality of bone nodes of the skinned mesh model; and
driving the skinned mesh model based on the bone driving factors of the plurality of bone nodes.
